(19) United States
(12) Patent Application Publication
(10) Pub. No.: US 2007/0005658 A1
(43) Pub. Date: Jan. 4, 2007

(54) System, service, and method for automatically discovering universal data objects

(75) Inventor: Jussi Petri Myllymaki, San Jose, CA (US)

Correspondence Address: SAMUEL A. KASSATLY LAW OFFICE, 20690 VIEW OAKS WAY, SAN JOSE, CA, 95120, US

(73) Assignee: International Business Machines Corporation

(21) Appl. No.: 11/174,212

(22) Filed: Jul. 2, 2005

(51) Int. Cl. G06F 17/30

(52) U.S. Cl. 707/200

(57) ABSTRACT

A universal data object discovery system automatically identifies candidate universal data objects, ranks the candidate universal data objects according to predetermined criteria, and merges source schemas into unified universal data objects within a set of data sources. From data inputs and a set of control parameters, the system computes a degree of sharing score for composite structures in the source schemas. The data inputs comprise source schemas, similarity values for data structures, and foreign key relationships. The system identifies as candidate universal data objects those structures whose degree of sharing score exceeds a threshold. The system calculates a similarity between candidate universal data objects and merges candidate universal data objects that are similar. The merged universal data objects are the output of the system.

### FIELD OF THE INVENTION

The present invention generally relates to database management systems. In particular, the present system relates to defining and unifying objects in different data sources to share data between data sources or merge data sources into a target data structure.

### BACKGROUND OF THE INVENTION

Databases are commonly used in businesses and organizations to manage information on employees, clients, products, etc. These databases are often custom databases generated by the business or organization or purchased from a database vendor or designer. Information management techniques and goals are continually evolving, requiring integration of databases into a common database or a sharing of data between databases. For example, a business with an extensive customer database may acquire another company. The business wishes to merge or integrate the customer databases or otherwise share information that is common in purpose. To merge or integrate source databases into a target database, the source databases are typically manually analyzed on a field-by-field or table-by-table basis to identify common structures in which data can be integrated or shared.

Information integration requires identification of objects (i.e., data structures) that are common in purpose to the data sources or databases being integrated. For example, company A with database A has merged with company B with database B. Both database A and database B are designed to track orders. Company A defines a customer object within database A as comprising the name of the customer, the location of the customer, and the revenue of the customer. Company B defines a customer object within database B as comprising the name of the customer, the location of the customer, and the number of employees associated with the customer. The name and location of the customer are common attributes of the customer object and can be shared between customer A and customer B provided a method for sharing can be achieved.

These common objects, referenced herein as universal data objects, facilitate effective querying and use of integrated data by presenting a common data interface to sources. Universal data objects further facilitate an understanding by application developers and database administrators of the content of data sources and how to navigate between objects and attributes within the data sources. Universal data objects can be used as the target of schema mapping; different sources can be mapped to the same set of universal data objects, making the sources appear uniform.

A conventional approach to defining universal data objects requires manual examination of objects residing in different sources (Application Specific Business Objects, or ASBOs). The manually identified objects (sometimes referred to as Generic Business Objects, or GBOs) are then typically unified according to some unwritten set of heuristics and “rules of thumb”. This approach is highly subjective and error-prone because of human involvement. Furthermore, this approach is not scalable to large numbers of sources and objects.

Thus, there is a need for a method that replaces the manual process of defining and unifying objects in databases with an automated one, making universal data object discovery more objective, more scalable, and less error-prone than conventional approaches. What is therefore needed is a system, a service, a computer program product, and an associated method for automatically discovering universal data objects. The need for such a solution has heretofore remained unsatisfied.

### SUMMARY OF THE INVENTION

The present invention satisfies this need, and presents a system, a service, a computer program product, and an associated method (collectively referenced herein as “the system” or “the present system”) for automatically discovering universal data objects (also referred to as Universal Business Objects, or UBOS) in a set of data sources. The purpose of a universal data object is exchange of these objects at a desired level of granularity. The present system automatically identifies candidate universal data objects, ranks the candidate universal data objects according to predetermined criteria, and merges source schemas into one or more unified universal data objects within the set of data sources.

The present system comprises a schema processing module, a clustering module, and a merging module. From data inputs and a set of control parameters, the schema processing module computes a degree of sharing score for composite structures in the source schemas. The data inputs comprise source schemas expressed as leaf-level data elements and tree-like composite structures, one or more similarity values of elementary and composite data structures across and within data sources, and one or more foreign key relationships across and within data sources.

The schema processing module ranks structures with respect to an associated degree of sharing score and identifies as candidate universal data objects those structures whose degree of sharing score exceeds a predetermined threshold. Control parameters place further restrictions on candidate universal data objects. The control parameters comprise a minimum and maximum size of the universal data object in terms of bytes, a minimum and maximum difference in cardinality (number of instances) between a parent and a child in the candidate universal data object, and a minimum degree of sharing of the candidate universal data objects.

The merging module calculates a similarity between candidate universal data objects and merges candidate universal data objects that are similar. Merging by the merging module comprises taking an intersection of the schemas of the candidate universal data object or taking a union of the schemas of the candidate universal data object. The merged universal data objects are the output of the present system.

The present system may be embodied in a utility program such as a universal data object discovery utility program. The present system also provides means for the user to identify a universal data object by specifying a set of data sources comprising schema similarity values, specifying a set of control parameters, specifying any required additional metadata, and then invoking the universal data object discovery utility to search and identify such universal data objects. The set of control parameters comprises a minimum and maximum size of the universal data object, a minimum and maximum difference in relative cardinality (number of instances) between a parent and a child in the a candidate universal data object, and a minimum value for a degree of sharing score of a candidate universal data object.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a universal data object discovery system of the present invention can be used;

FIG. 2 is a block diagram of the high-level architecture of the universal data object discovery system of FIG. 1;

FIG. 3 is a process flow chart illustrating a method of operation of the universal data object discovery system of FIGS. 1 and 2;

FIG. 4 is comprised of FIGS. 4A and 4B and represents a process flow chart illustrating a method of operation of a schema processing module of the universal data object discovery system of FIGS. 1 and 2 in processing source schemas to identify candidate universal data objects;

FIG. 5 is a process flow chart illustrating a method of operation of a selection module of the universal data object discovery system of FIGS. 1 and 2 in selecting candidate universal data objects;

FIG. 6 is comprised of FIGS. 6A and 6B and represents a process flow chart illustrating a method of operation of a clustering module of the universal data object discovery system of FIGS. 1 and 2 in clustering source schemas according to candidate universal data objects;

FIG. 7 is a schema diagram illustrating a set of exemplary source schemas for processing by the universal data object discovery system of FIGS. 1 and 2;

FIG. 8 is a schema diagram illustrating the exemplary source schemas with structural sharing scores determined by the universal data object discovery system of FIGS. 1 and 2 for the object graph of FIG. 7;

FIG. 9 is a schema diagram illustrating the exemplary source schemas with value similarity scores determined by the universal data object discovery system of FIGS. 1 and 2 for the object graph of FIG. 7;

FIG. 10 is a schema diagram illustrating the exemplary source schemas with foreign key scores determined by the universal data object discovery system of FIGS. 1 and 2 for the object graph of FIG. 7;

FIG. 11 is a schema diagram illustrating candidate universal data objects identified by the universal data object discovery system of FIGS. 1 and 2 for the object graph of FIG. 7;

FIG. 12 is a schema diagram illustrating candidate universal data objects clustered by the universal data object discovery system of FIGS. 1 and 2 for the object graph of FIG. 7;

FIG. 13 is a schema diagram illustrating similarities between candidate universal data objects determined by the universal data object discovery system of FIGS. 1 and 2 for the object graph of FIG. 7; and

FIG. 14 is a schema diagram illustrating candidate universal data objects merged into universal data objects by the universal data object discovery system of FIGS. 1 and 2 for the object graph of FIG. 7.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Attribute: an element of an object. Attributes can be simple, comprising only one attribute, or complex, comprising additional attributes in a structure. Attributes can also be repeating, occurring more than once.

Cardinality: A number of instances of a value or item occurring in a data structure element such as an object or an attribute.

Foreign key: a key that uniquely relates one object with another object.

Object: a data structure element in a schema or an object graph.

Universal Data Object: An object with elements and function in common across different data sources.

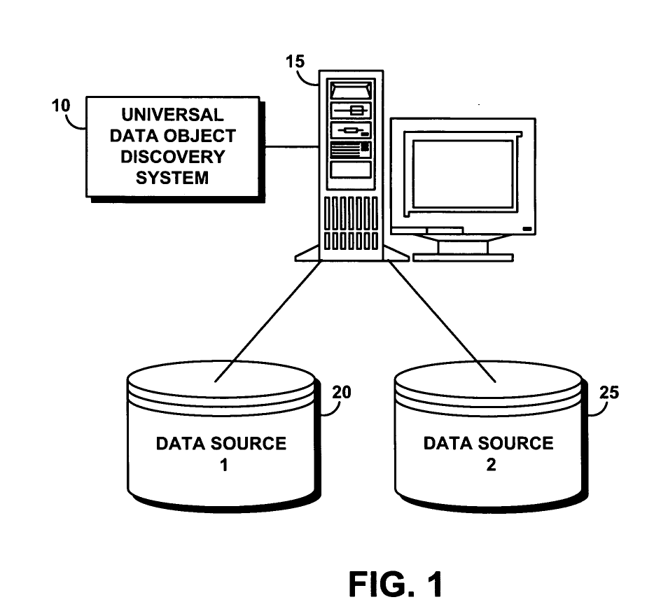

FIG. 1 portrays an exemplary overall environment in which a system, a service, a computer program product, and an associated method for automatically discovering universal data objects according to the present invention may be used. System 10 comprises a software programming code or a computer program product that is typically embedded within, or installed on a computer 15. Alternatively, system 10 can be saved on a suitable storage medium such as a diskette, a CD, a hard drive, or like devices. Input to system 10 is a data source 1, 20, and a data source 2, 25. System 10 examines one or more schemas in data source 1, 20, and schemas data source 2, 25, identifying and unifying, as desired, one or more universal data objects in data source 1, 20, or data source 2, 25. While system 10 is described in terms of a database, it should be clear that system 10 is applicable as well to, for example, any data source comprising a set of values.

The data source 1, 20, comprises a data structure that comprises schemas. For the data source 1, 20, similarities between the schemas in the data structure of the data source 1, 20, have been determined. Furthermore, cardinalities (instances) of objects and attributes within the data source 1, 20, have been determined and foreign keys have been identified.

The data source 2, 25, comprises a data structure that comprises schemas. For the data source 2, 25, similarities between the schemas in the data structure of the data source 2, 25, have been determined. Furthermore, cardinalities (instances) of objects and attributes within the data source 2, 25, have been determined and foreign keys have been identified.

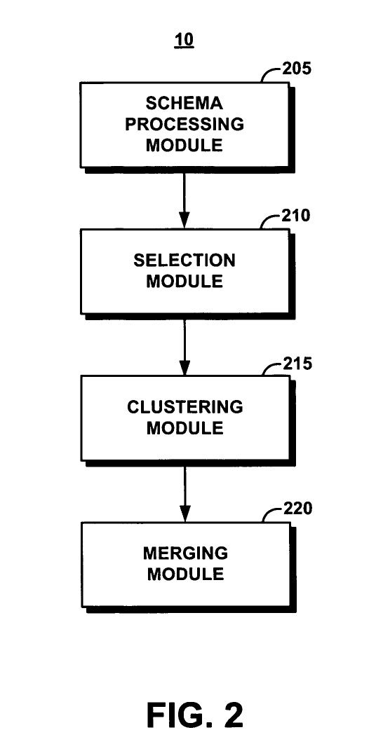

FIG. 2 illustrates an exemplary high-level architecture of system 10. System 10 comprises a schema processing module 205, a selection module 210, a clustering module 215, and a merging module 220.

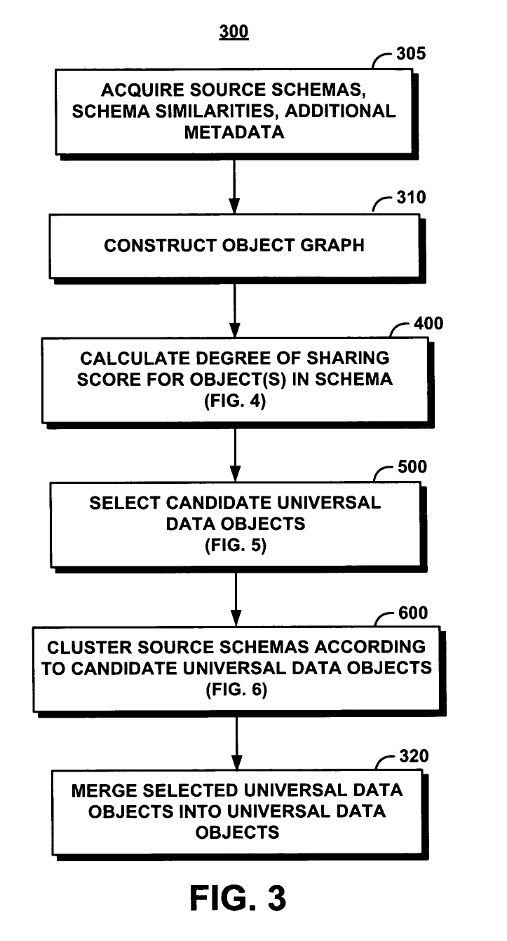

FIG. 3 illustrates a method 300 of operation of system 10. System 10 acquires as input (step 305) source schemas for the data source 1, 20, and the data source 2, 25 (further referenced herein in general as source schemas). System 10 acquires further input comprising similarity scores between the schema of data source 1, 20, and the schema of data source 2, 25 (further referenced herein in general as similarity scores). System 10 acquires additional metadata comprising user input for control parameters. The control parameters comprise a minimum and maximum size of the universal data object in terms of bytes, a minimum and maximum difference in cardinality (number of instances) between a parent and a child in the candidate universal data object, and a minimum degree of sharing of the candidate universal data objects.

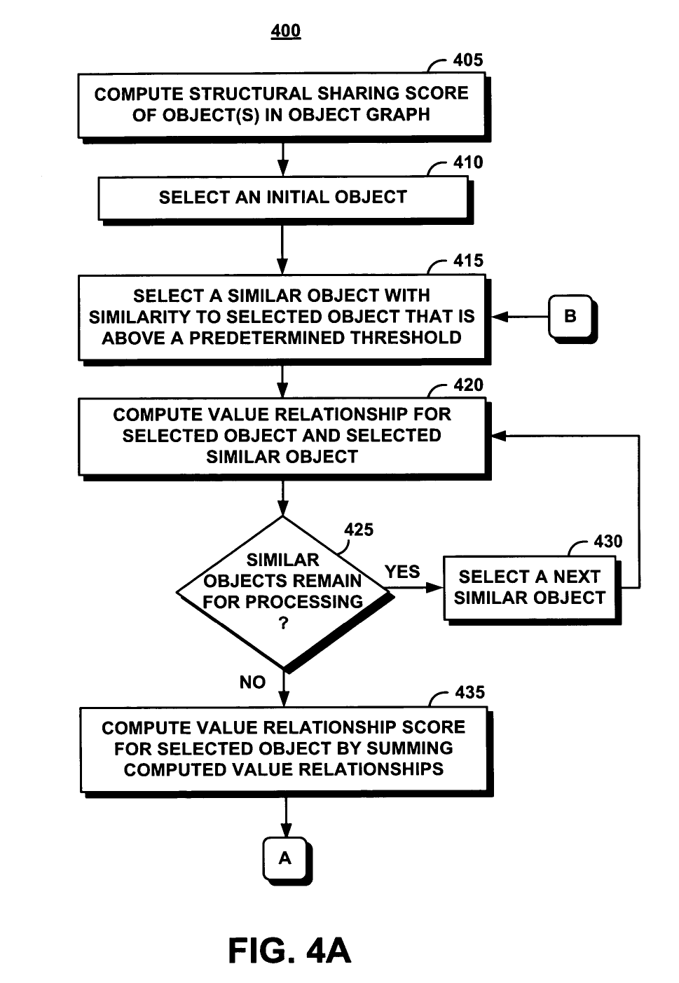

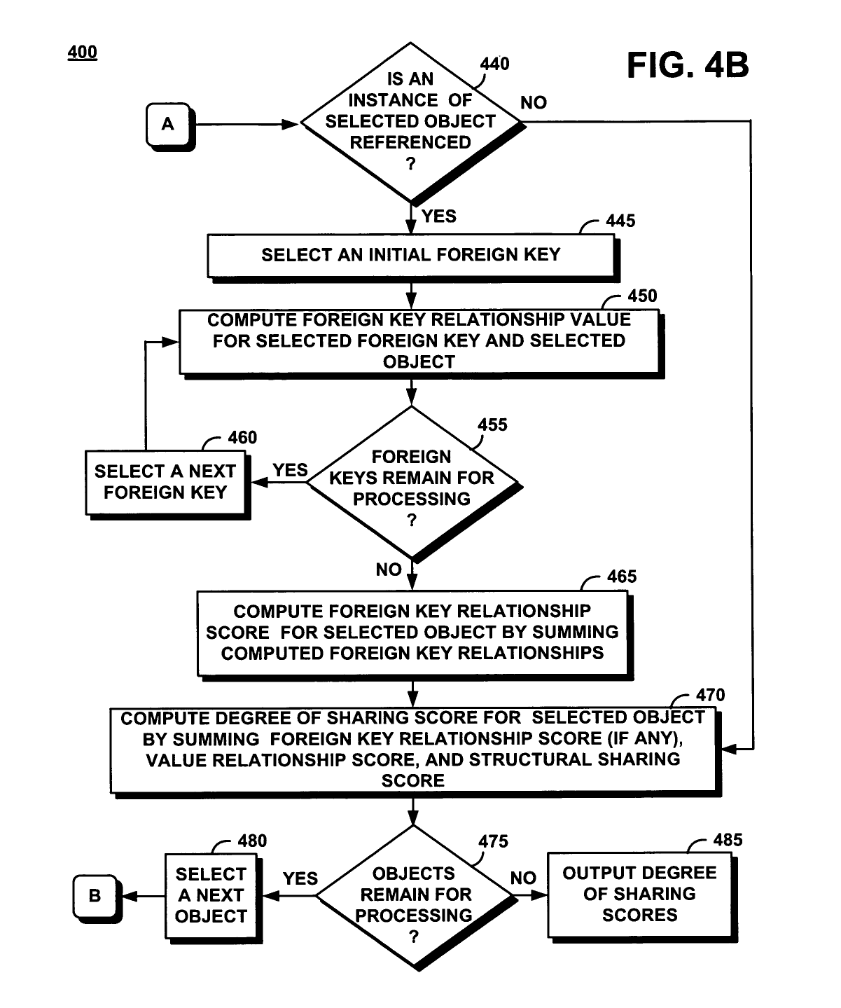

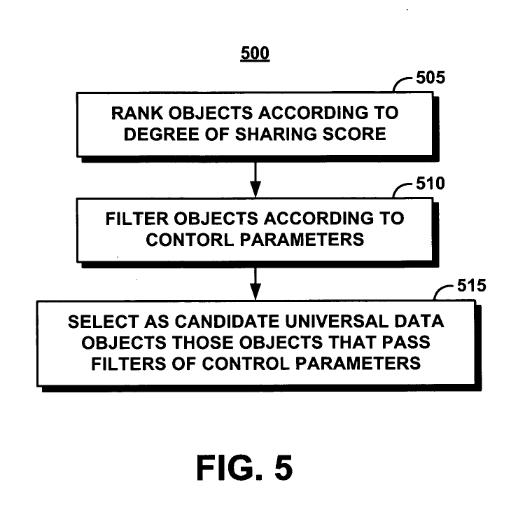

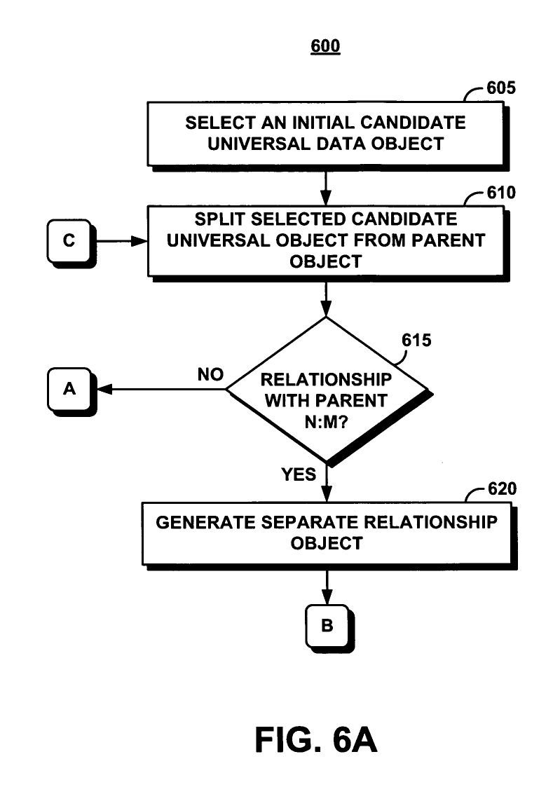

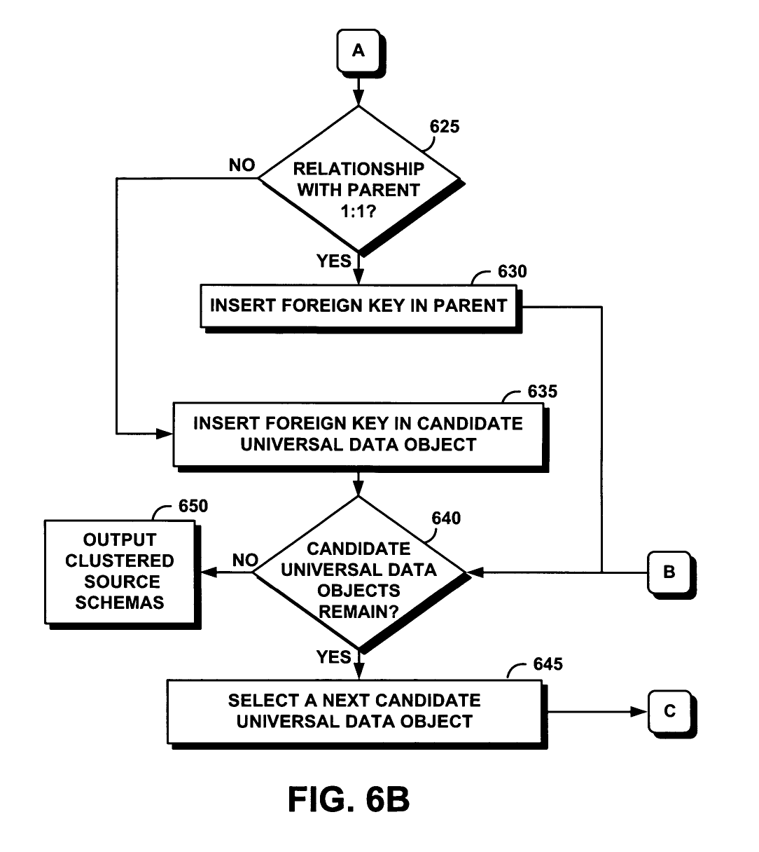

The schema processing module 205 constructs a single object graph that represents some or all of the source schemas (step 310). The schema processing module 205 adds to the object graph pairwise similarity scores and functional dependency information received as input. The schema processing module 205 computes a degree of sharing score for objects in the object graph (step 400, further described in FIG. 4). The selection module 210 selects candidate universal data objects (step 500, further described in FIG. 5) as universal data objects. The clustering module 215 clusters the source schemas according to the selected universal data objects (step 600, further described in FIG. 6). The merging module 220 merges the selected universal data sources in the source schemas into merged universal data objects (step 315).

In one embodiment, the merging module 220 applies an intersection semantic to selected universal data sources that are to be merged. The intersection semantic merges those attributes that are common to all the similar selected universal data objects. Attributes found in selected universal data objects that are not in common are pruned. In another embodiment, the merging module 220 applies a union semantic to selected universal data sources that are to be merged. The union semantic merges those attributes that are found in any of the universal data objects.

FIG. 4 (FIGS. 4A, 4B) illustrates a method 400 of the schema processing module 205 in determining degree of sharing scores for objects in the object graph. The degree of sharing score for an object O is calculated as the sum of a structural sharing score, a value relationship score, and a foreign key relationship score, as illustrated in method 400.

The schema processing module 205 computes a structural sharing score for one or more objects in the object graph (step 405). For the selected attribute, the schema processing module 205 considers a number of parent structures or a chain of ancestors associated with the selected attribute. Each link in the object graph of an object to a parent or superclass contributes to the structural sharing score of the selected object; i.e., the more parents or superclasses an object O has, the higher the score. For example, a link from object O to its immediate parent(s) has a structural sharing value of 1.0. Links to the parents of the parents of object O have a structural sharing value of 0.5. Each level of ancestry has a structural sharing value that is one-half of the structural sharing value of an immediately lower level. For instance, if object O is 3 levels down from a root in a tree structure, object O has a structural sharing score of 1+0.5+0.25=1.75. The position-dependent structural sharing score is calculated as the sum of the distances from the object to each of the ancestors of the object according to the following equation:
Score=Σ(½)⁽ⁿ⁻¹⁾,
where n is the distance from the object to the ancestor measured as the number of links.

The schema processing module 205 selects an initial object in the object graph (step 410). The schema processing module 205 selects a similar object with a similarity to the selected object that is above a predetermined threshold (step 415). The schema processing module 205 computes a value relationship for the selected object and the selected similar object (step 420) by multiplying the similarity of the selected similar object by the structural sharing value of the selected similar object. Computation of the value relationship considers the similarity of object O to other objects and uses the structural sharing value of those other objects to increase the value relationship score of object O. For instance, if object O is similar to object X (with a similarity value 0.8) and object X has a structural sharing value of 1.5, then the computed value relationship between object O and object X is 0.8*1.5.

The schema processing module 205 determines whether additional remain for processing for the selected object (decision step 425). If yes, the schema processing module 205 selects a next similar object, a next object that has a similarity to the selected object that is above a predetermined threshold (step 430). The schema processing module 205 computes the value relationship for this next similar object and the selected object as before (step 420). The schema processing module 205 repeats step 420 through step 430 until no additional objects remain with similarity to the selected object above a predetermined threshold.

The schema processing module 205 computes a value relationship score for the selected object by summing the computed value relationships determined in step 420 through step 430 (step 435). The schema processing module 205 performs step 415 through step 430 for simple attributes and complex attributes.

The schema processing module 205 determines whether an instance of the selected object is referenced by another object (decision step 440). If yes, a foreign key relationship in another object points to the selected object. A foreign key relationship indicates that a specific instance of object O (i.e., a key field of object O) is referenced by another object X (i.e., a foreign key field of object X).

The schema processing module 205 selects an initial foreign key referencing the selected object (step 445). The schema processing module 205 computes a foreign key relationship value for the selected foreign key and the selected object (step 450) by multiplying a foreign key strength for the selected foreign key by the structural sharing score of the primary key in the selected object to which the foreign key is pointing. If, for example, the foreign key relationship has foreign key strength of 0.9 and object X has a structural sharing score of 1.75, the computed foreign key relationship value is 0.9*1.75.

The schema processing module 205 determines whether additional foreign keys that reference an instance of the selected object remain for processing (decision step 445). If yes, the schema processing module 205 selects a next foreign key (step 460). The schema processing module 205 computes the foreign key relationship for this next foreign key and the selected object as before (step 450). The schema processing module 205 repeats step 450 through step 460 until no additional foreign keys remain that reference an instance of the selected object.

The schema processing module 205 computes a foreign key relationship score for the selected object by summing the computed foreign key relationship values determined in step 450 through step 460 (step 465).

The schema processing module 205 computes a degree of sharing score for the selected object by summing the foreign key relationship score (if any), the value relationship score, and the structural sharing score (step 470). If no instances of the selected object are referenced in decision step 440, no foreign key relations exist for the selected object and no foreign key relationship score is computed.

The schema processing module 205 determines whether additional objects remain for processing (step 475). If yes, the schema processing module selects a next object (step 480) and repeats step 415 through step 480 until no additional objects remain for processing. The schema processing module 205 outputs degree of sharing scores for objects in the object graph (step 485).

FIG. 5 illustrates a method 500 of the selection module 210 in selecting candidate universal data objects. The selection module 210 ranks objects in the object graph according to the degree of sharing scores determined by the schema processing module 205 (step 505). The selection module 210 filters the ranked objects according to predetermined control parameters, placing further restrictions on selection of candidate universal data objects. Universal data objects are objects of a size that is desirable for exchange between source schemas. Objects that are too large, too small, appear too many times, or appear too few times are not desirable candidates for exchange. The control parameters filter the candidate universal data objects with respect to desirability of exchange of the objects.

The control parameters comprise a range in desirable size of a candidate universal data object; the range in desirable size comprises a minimum size and a maximum size. For example, a candidate universal data object can be an “address” of a person comprising 200 bytes; 200 bytes is a reasonable size for a universal data object. An example of an object that is not a reasonable selection for a universal data object is a CAD design comprising 1 GB. Another example of an object that is not a reasonable selection for a universal data object is a “name” of a person comprising 20 bytes; 20 bytes is generally too small for a universal data object. However, the “name” of a person may be an attribute of a universal data object.

The control parameters further comprise a range in relative cardinality (number of instances) of a candidate universal data object with respect to the parent of the candidate universal data object; the range in cardinality comprises a minimum and a maximum difference in relative cardinality between a candidate universal data object and the parent of the candidate universal data object.

The control parameters comprise a minimum degree of sharing score for the candidate universal data object. The degree of sharing score for candidate universal data objects is above a predetermined threshold that is the minimum degree of sharing score. Candidate universal data objects are objects that are common in the source schemas. The degree of sharing score indicates how common an object is in the source schema; objects that are desirable as candidate universal data objects have a desirable degree of sharing score. The selection module 210 selects as candidate universal data objects those objects that pass the filters of the control parameters (step 515).

FIG. 6 (FIGS. 6A, 6B) illustrates a method 600 of the clustering module 215 in clustering candidate universal data objects. The clustering module 215 selects an initial candidate universal data object (step 605). The clustering module 215 splits the candidate universal data object from the parent object (step 610). The clustering module 215 determines whether the candidate universal data object comprises an N:M relationship with the parent of the candidate universal data object (decision step 615). If the relationship between the parent and the candidate universal data object is N:M, the clustering module 215 generates a separate relationship object to replace the N:M relationship (step 620) and links a primary key in the parent and the universal data object to the separate relationship object.

Otherwise, if the result of decision step 615 is no, the clustering module 215 determines whether the relationship between the parent and the candidate universal data object is 1:1 (decision step 625). If the relationship between the parent and the candidate universal data object is 1:1, the clustering module 215 inserts a foreign key into the parent (step 630) and links the inserted foreign key to a primary key in the universal data object. Otherwise, (if the relationship between the parent and the candidate universal data object is not N:M or 1:1), the relationship between the parent and the candidate universal data object is 1:N and the clustering module 215 inserts a foreign key in the candidate universal data object (step 635) and links the inserted foreign key to a primary key in the parent.

After creating a separate relationship object (step 620), inserting a foreign key in the parent (step 630), or inserting a foreign key in the candidate universal data object (step 635), the clustering module 215 determines if additional candidate universal data objects remain for processing (decision step 640). If yes, the clustering module 215 selects a next candidate universal data object (step 645) and repeats step 610 through step 645 until no additional candidate universal data objects remain for processing.

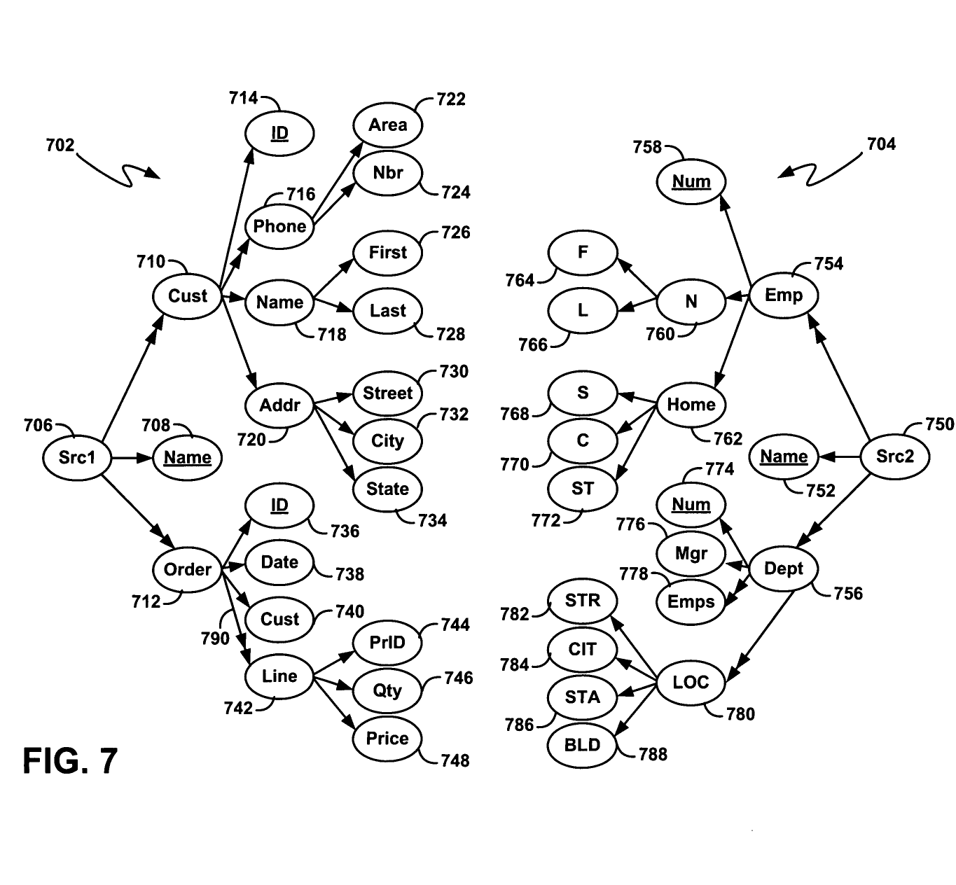

FIG. 7 represents an exemplary object graph generated by system 10, presented for illustration purposes. Object graph 702 represents, for example, an exemplary object graph generated for data source 1, 20, and object graph 704 represents, for example, an exemplary object graph generated for data source 2, 25.

A source 1 (Src1 706) comprises an identifier (Name 708), a customer object (Cust 710), and an order object (Order 712). Cust 710 comprises an identifier (ID 714), a phone object (phone 716), a name object (Name 718), and an address object (Addr 720). Phone 716 comprises an area code attribute (Area 722) and a phone number attribute (Nbr 724). Name 718 comprises a first name attribute (First 726) and a last name attribute (Last 728). Addr 720 comprises a street attribute (Street 730), a city attribute (City 732), and a state attribute (State 734). Order 712 comprises an identifier (ID 736), a date attribute (Date 738), a customer attribute (Cust 740), and a line item object (Line 742). Line 742 comprises an identifier (PrID 744), a quantity attribute (Qty 746), and a price attribute (Price 748).

A source 2 (Src2 750) comprises an identifier (Name 752), an employee object (Emp 754), and a department object (Dept 756). Emp 754 comprises an identifier (Num 758), a name object (N 760), and a home address object (Home 762). N 760 comprises a first name attribute (F 764) and a last name attribute (L 766). Home 762 comprises a street attribute (S 768), a city attribute (C 770), and a state attribute (ST 772). Dept 756 comprises an identifier (Num 774), a manager attribute (Mgr 776), an employee attribute (Emps 778), and a location object (LOC 780). LOC 780 comprises a street attribute (STR 782), a city attribute (CIT 784), a state attribute (STA 786), and a building attribute (BLD 788).

One to many relationships (1:N) or many to many relationships (N:M) between parent and child are indicated in the object graph 702 and the object graph 704 as a double arrow, represented by double arrow 790.

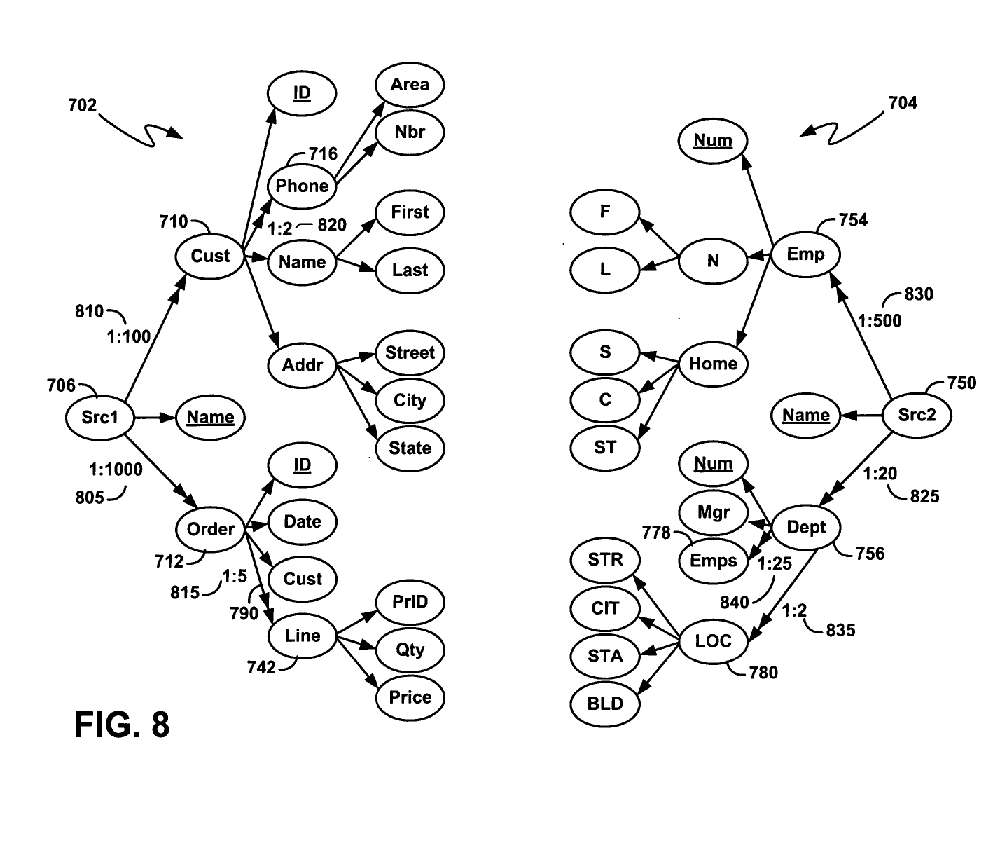

The schema processing module 205 quantifies the relationship values between parent and child, as shown in FIG. 8. A relationship value 805 of 1:1000 is identified between Src1 706 and Order 712. A relationship value 810 of 1:100 is identified between SRC1 706 and Cust 710. A relationship value 815 of 1:5 is identified between Order 712 and Line 742. A relationship value 820 of 1:2 is identified between Cust 710 and Phone 716. A relationship value 825 of 1:20 is identified between Src2 and Dept 756. A relationship value 830 of 1:500 is identified between Src2 750 and Emp 754. A relationship value 835 of 1:2 is identified between Dept 756 and LOC 780. A relationship value 840 of 1:25 is identified between Dept 756 and Emps 778.

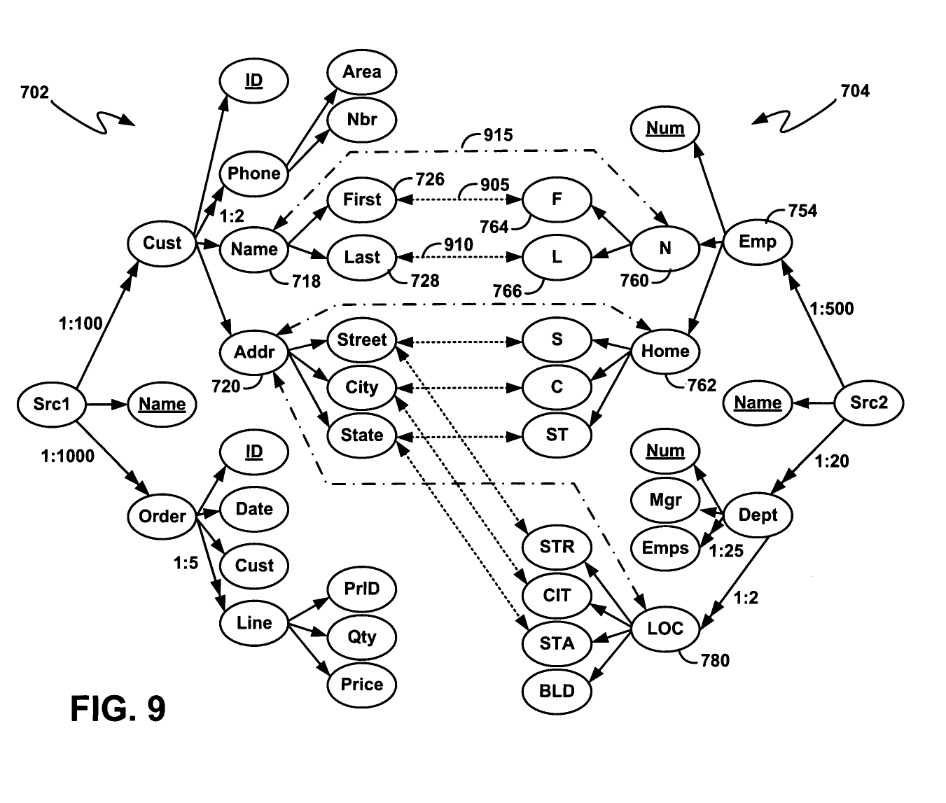

The schema processing module 205 identifies similarities between attributes and objects that exceed a predetermined threshold as shown in FIG. 9 and computes structural sharing scores. Identified similarities are illustrated in an exemplary manner as dashed lines between similar attributes (i.e., similarity 905 and 910) and as dash-dot-dash lines between similar objects (i.e., similarity 915).

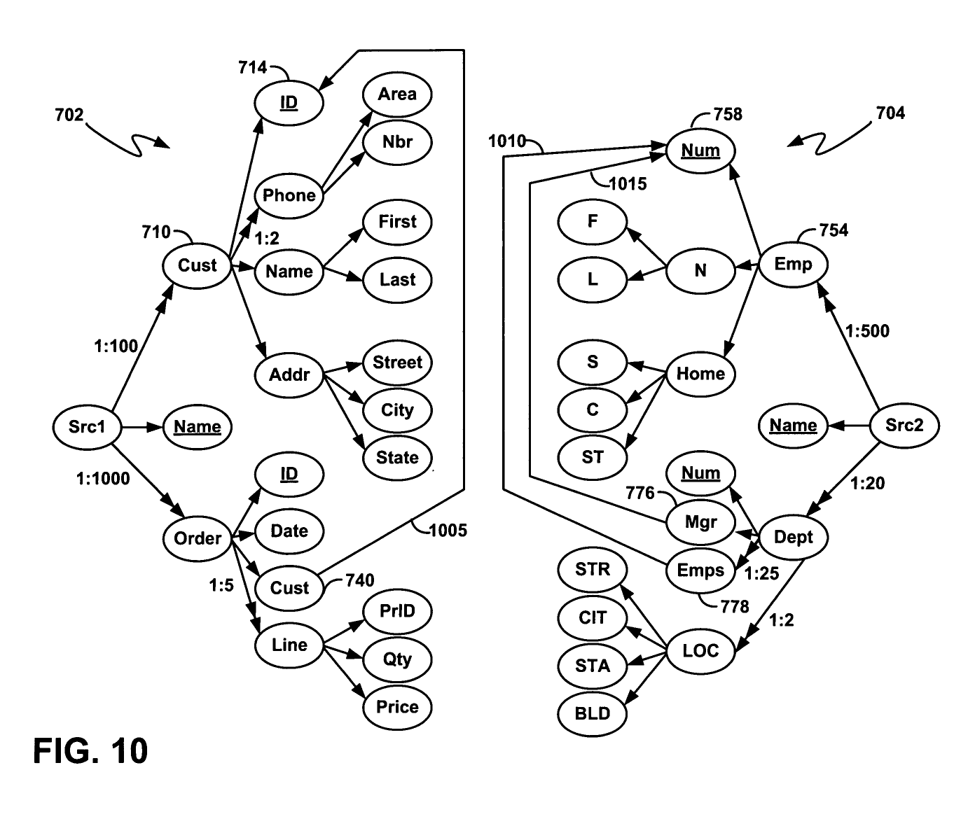

The schema processing module 205 identifies foreign keys in object graph 702 and object graph 704 and calculates foreign key scores, as illustrated in FIG. 10. Cust 740 references ID 714 in Cust 710 as a foreign key, indicated by line 1005. Emps 778 references Num 758 in Emp 754 as a foreign key, indicated by line 1010. Mgr 776 references Num 758 in Emp 754 as a foreign key, indicated by line 1015.

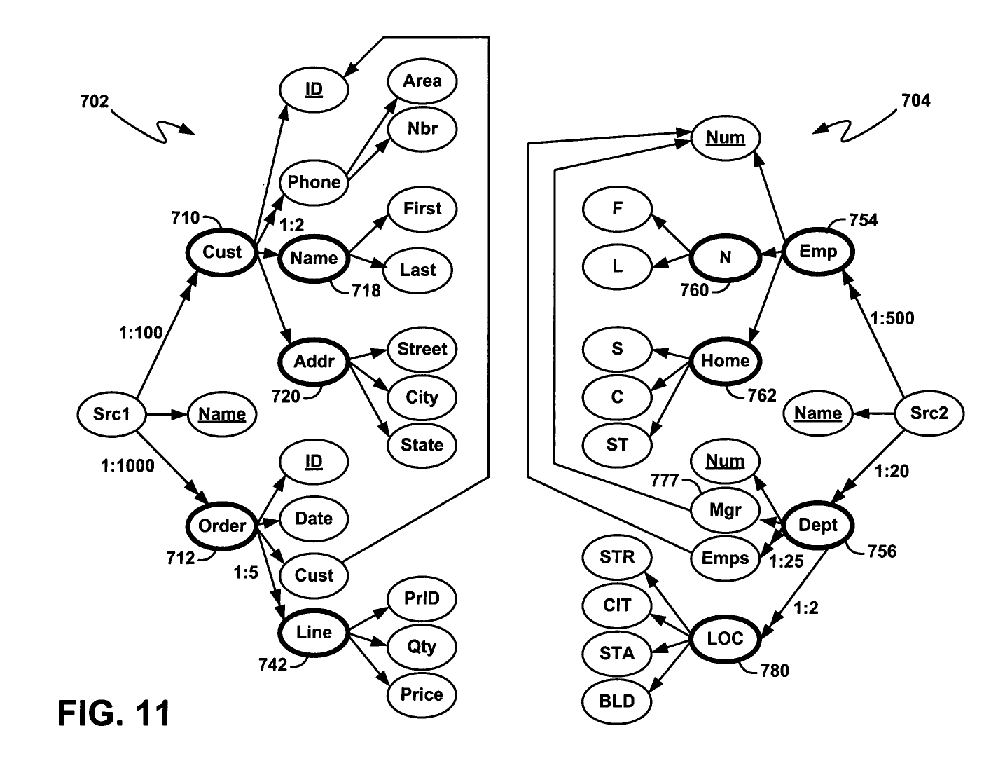

The schema processing module 205 uses the foreign key scores (FIG. 10), the structural sharing scores (FIG. 9), and the relationship values (FIG. 8) to calculate degree of sharing. The selection module 210 selects candidate universal data objects as indicated in FIG. 11 in bold ovals. For example, the selection module 210 selected Cust 710, Order 712, Name 718, Addr 720, Line 742, Emp 754, Dept 756, N 760, Home 762, and LOC 780 as candidate universal data objects.

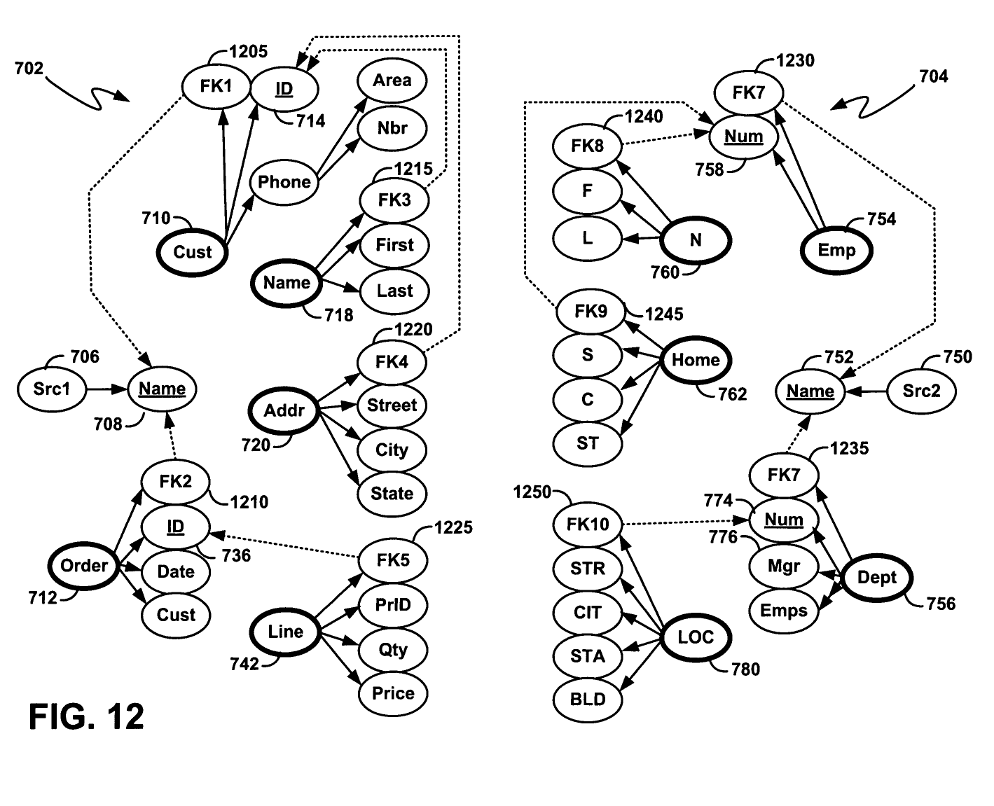

The clustering module 215 splits candidate universal data objects from parent objects and inserts foreign keys as indicated in FIG. 12. The clustering module 215 separated Cust 710 from Src1 706, inserted a foreign key (FK1 1205), and replaced the link to Src1 706 with a link from FK1 1205 to the identifier for Src1 706, Name 708. The clustering module 215 separated Order 712 from Src1 706, inserted a foreign key (FK2 1210), and replaced the link to Src1 706 with a link from FK2 1210 to the identifier for Src1 706, Name 708.

The clustering module 215 separated Name 718 from Cust 710, inserted a foreign key (FK3 1215), and replaced the link to Cust 710 with a link from FK3 1215 to the identifier for Cust 710, ID 714. The clustering module 215 separated Addr 720 from Cust 710, inserted a foreign key (FK4 1220), and replaced the link to Cust 710 with a link from FK4 1220 to the identifier for Cust 710, ID 714. The clustering module 215 separated Line 742 from Order 712, inserted a foreign key (FK5 1225), and replaced the link to Cust 710 with a link from FK5 1225 to the identifier for Order 712, ID 736.

The clustering module 215 separated Emp 754 from Src2 750, inserted a foreign key (FK6 1230), and replaced the link to Src2 750 with a link from FK6 1230 to the identifier for Src2 750, Name 752. The clustering module 215 separated Dept 756 from Src2 750, inserted a foreign key (FK7 1235), and replaced the link to Src2 750 with a link from FK7 1235 to the identifier for Src2 750, Name 752.

The clustering module 215 separated N 760 from Emp 754, inserted a foreign key (FK8 1240), and replaced the link to Emp 754 with a link from FK8 1240 to the identifier for Emp 754, Num 758. The clustering module 215 separated Home 762 from Emp 754, inserted a foreign key (FK9 1245), and replaced the link to Emp 754 with a link from FK9 1245 to the identifier for Emp 754, Num 758. The clustering module 215 separated LOC 780 from Dept 756, inserted a foreign key (FK10 1250), and replaced the link to Dept 756 with a link from FK1 0 1250 to the identifier for Dept 756, Num 774.

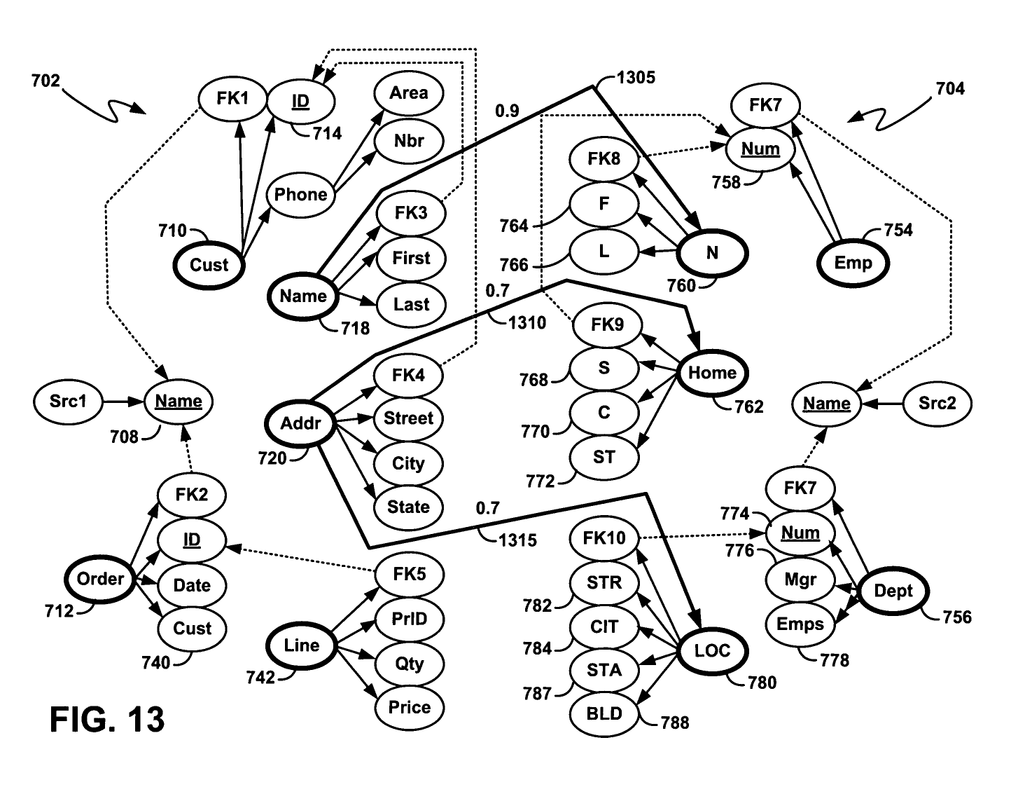

System 10 selects universal data objects as indicated in FIG. 13. Line 1305 indicates an acceptable similarity score (0.9) between Name 718 and N 760. Line 1310 indicates an acceptable similarity score (0.7) between Addr 720 and Home 762. Line 1315 indicates an acceptable similarity score (0.7) between Addr 720 and LOC 780.

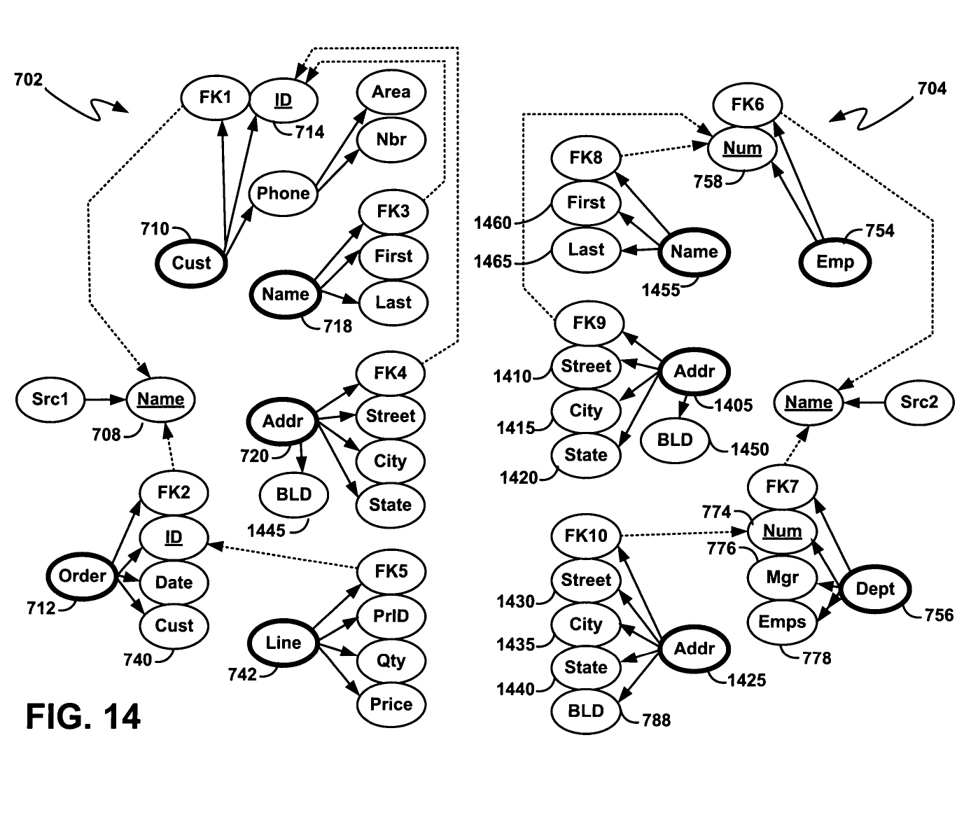

System 10 merges the selected universal data objects as indicated in FIG. 14. Home 762 and attributes S 768, C 770, and ST 772 become Addr 1405 with attributes Street 1410, City 1415, and State 1420. LOC 780 with attributes STR 782, CIT 784, and STA 786 become Addr 1425 with attributes Street 1430, City 1435, and State 1440. In this example, universal data objects are merged using the union semantic, and BLD 788 is added to Addr 720 as BLD 1445 and to Addr 1405 as BLD 1450. N 760 with attributes F 764 and L 766 becomes Name 1455 with attributes First 1460 and Last 1465.

Pseudocode for system 10 can be summarized as:

```
data structure schema
  element id string
  element instances integer
  element cardinality integer
end data structure
data structure link
  element to schema
  element from schema
  element strength float
  element type enum { parent, subset, foreign-key, superclass }
end data structure
data structure graph
  set { link }
end data structure
function getubos(sources S, graph G, queries Q)
-- Find universal data objects for set of sources, queries, and graph.
let B := { schemas(S) } U { schemas(Q) }
```

| | |
|---|---|
| let maxsize := 1MB | -- maximum size of a universal data object |
| instance | |
| let mininst := 2 | -- minimum # instances of universal data |
| object | |
| let minsharing := 2 | -- minimum degree of sharing of universal |
| data object | |
| let minstrength := 0.8 | -- threshold for merging two schemas |

```
do
  let done := true
  -- Split large schemas into smaller ones
  for b in B (sort by size(b), decreasing order)
    let split := split(G, b)
    -- Structure of b in B may have been modified above
    -- (child schemas replaced with pointers).
    if size(split) > 0 then
      let B := B U split
      done := false
    end if
  end for
  -- Merge compatible schemas into one.
  for l in G (sort by l.strength, decreasing order)
    where l.type == subset and l.strength > minstrength
    let G := rename(G, l.from, t.to)
    let B := B \ l.from \ l.to U merge(l.from, l.to)
    done := false
  end for
while not(done)
return B
function sharing-structure(graph G, schema b)
-- Return measure of structural sharing of schema b. Each link to
-- a parent or superclass contributes to score. The more parents
-- or superclasses schema b has, the higher the score.
-- The weight of a link decreases the further away from b one gets
-- in the graph. Strength l.strength is probably always 1.0.
let s := 0.0
let f := 1.0
let B := { b }
for b in B
  for l in G
    where l.from == b and (l.type == parent or l.type == superclass)
    let s := s + f * l.strength
    let B := B U { l.to }
  end for
  let f := f / 2
  let B := B \ { b }
end for
return s
function sharing(graph G, schema b)
-- Return measure of sharing of schema b. Get measure of
-- structural sharing for b. Then traverse similarity links
-- (subsets and supersets) as well as foreign key relationships.
-- The weight of a link decreases the further away from b one gets
-- in the graph.
-- Get score for structural sharing.
let s := sharing-structure(G, b)
-- Add score from subset similarity (b is the superset).
for l in G
  where l.to == b and l.type == subset
  let s := s + l.strength * sharing-structure(l.from)
end for
-- Add score from foreign key relationships (child of b is key).
for l in G
  where l.to == b and l.type == parent and iskey(l.from, l.to)
  for l2 in G
    where l2.to == l.from and l.type == foreign-key
    let s := s + l2.strength * sharing-structure(l2.from)
  end for
end for
return s
function iskey(schema child, schema parent)
-- Return true if child is key for parent.
return child.cardinality == parent.instances
function rename(graph G, schema f, schema t)
-- Replace occurrences of name f with name t. Remove
-- links from f to t.
for l in G
  if l.from == f and l.to == t then remove g from G
  if l.from == f then set l.from = t
  if l.to == f then set l.to = t
end for
return G
function split(graph G, schema b)
-- Find universal data objects in schema b and split them off by
replacing each one
-- with a pointer to child schema.
let newubos := findubos(G, b)
for ubo in newubos
  let fk := createkey(G, ubo)
  if fk == null
    -- Could not create key for new universal data object. Cannot do
split.
    continue
  end if
  -- Key becomes part of new universal data object.
  let link := { from = fk, to = ubo, type = parent, strength = 1.0 }
  let G := G U link
  -- Add foreign key relationship to all parents
  for l in G
    where l.from == ubo and l.type == parent
    let key := getkey(G, l.to)
    let link := { from = fk, to = key, type = foreign-key, strength =
1.0 }
    let G := G U link
  end for
  let G := G \ 1
end for
return newubos
function findubos(graph G, schema b)
-- Find list of universal data objects residing inside schema b that
can be split off.
let newubos := empty
for l in G
  where l.type == parent and l.from = b
  if size(b) > maxsize and size(l.to) < maxsize
    or b.instances < mininst and l.to.instances > mininst
    or sharing(G, b) < minsharing and sharing(G, l.to) > minsharing
    or sharing(G, l.to) > sharing(G, b) + 1
    or l.to.instances / b.instances > mininst
  then
    newubos := newubos U l.to
  else
    newubos := newubos U findubos(G, l.to)
  end if
end for
return newubos
function createkey(graph G, schema ubo)
-- Come up with a key for ubo that can be used as a foreign key to all
-- its parents.
let fk := null
for l in G
  where l.from == ubo and l.type == parent
  let key := getkey(G, l.to)
  if key == null then return null
  let fk := maxkey(fk, key)
end for
return fk
function getkey(graph G, schema b)
-- Return key for schema b.
for l in G
  if l.to == b and l.type == parent and iskey(l.from, l.to) then
    return l.from
end for
return null
function merge(schema f, schema t)
-- Merge schema f and t into one.
let new := new(schema)
let new.name = t.name
let new.instances = f.instances + t.instances
let new.cardinality = cardinality(union(f, t))
  return new
```

It is to be understood that the specific embodiments of the invention that have been described are merely illustrative of certain applications of the principle of the present invention. Numerous modifications may be made to the system, service, and method for automatically discovering universal data objects described herein without departing from the spirit and scope of the present invention. Moreover, while the present invention is described for illustration purpose only in relation to the databases, it should be clear that the invention is applicable as well to, for example, any data source than can be represented as an object graph.

What is claimed is:

1. A method of automatically discovering a plurality of universal data objects, comprising:
generating an object graph from a set of source schemas, a plurality of similarities between objects in the set of source schemas, and a plurality of additional metadata describing the set of source schemas;
calculating a degree of sharing score for a plurality of objects in the object graph;
selecting a plurality of candidate universal data objects from the objects in the object graph;
clustering the candidate universal data objects to select a plurality of universal data objects; and
merging the selected universal data objects to allow sharing of data between the set of source schemas.

2. The method of claim 1 wherein generating the additional the additional metadata comprises identifying foreign keys between two objects in the set of source schemas, and further identifying the strength of each foreign key.

3. The method of claim 1 wherein generating the additional the additional metadata comprises identifying a relative cardinality between an object and a parent of the object in the set of source schemas.

4. The method of claim 1 wherein generating the additional the additional metadata comprises identifying the size of each of the objects in the set of source schemas.

5. The method of claim 1 wherein calculating the degree of sharing score for each object comprises calculating the sum of:
a structural sharing score for the object;
a value relationship score for the object; and
a foreign key relationship score for the object.

6. The method of claim 5 wherein calculating the structural sharing score comprises calculating a value dependent on the position of the object relative to a root in the object graph.

7. The method of claim 6 wherein calculating the position-dependent structural sharing score comprises calculating the sum of the distances from the object to each of the ancestors of the object according to the following equation:
Score=Σ(½)⁽ⁿ⁻¹⁾,
where n is the distance from the object to the ancestor measured as the number of links.

8. The method of claim 5 wherein calculating the value relationship score comprises calculating the sum of the similarity of the object to another object times the structural sharing score of that other object.

9. The method of claim 5 wherein calculating the foreign key score comprises calculating, for each object that is an instance referenced by another object, the sum of the foreign key strength between a primary key of the object and a foreign key of the referencing object times the structural sharing score of the foreign key of the referencing object.

10. The method of claim wherein selecting candidate universal data objects comprises filtering objects with respect to control parameters.

11. The method of claim 10 wherein the control parameters comprise:
a minimum size and a maximum size of a candidate universal data object type;
a minimum and a maximum relative cardinality between the candidate universal data object and a parent of the candidate universal data object; and
a minimum value of a degree of sharing score of the candidate universal data object.

12. The method of claim 1 wherein clustering the candidate universal data objects comprises:
splitting a universal data object from its parent; and
inserting a foreign key in each universal data object if the relationship to its parent is as follows: one parent has multiple children.

13. The method of claim 1 wherein clustering the candidate universal data objects comprises:
splitting a universal data object from its parent; and
inserting a foreign key in each parent if the relationship of the universal data object to its parent is as follows: one parent has one child.

14. The method of claim 1 wherein clustering the candidate universal data objects comprises:
splitting a universal data object from its parent;
generating a separate relationship object if the relationship of the universal data object to its parent is as follows: one parent has multiple children and one child has multiple parents; and
inserting a first foreign key in the separate relationship object pointing to the parent and a second foreign key in the separate relationship object pointing to the universal data object.

15. The method of claim 1 wherein merging the selected universal data objects comprises merging attributes that are common to all the universal data objects being merged.

16. The method of claim 1 wherein merging the selected universal data objects comprises merging attributes that are in any of the universal data objects being merged.

17. A system for automatically discovering a plurality of universal data objects, comprising:
a schema processing module for generating an object graph from a set of source schemas, a plurality of similarities between objects in the set of source schemas, and a plurality of additional metadata describing the set of source schemas;
the schema processing module further calculating a degree of sharing score for a plurality of objects in the object graph;
a selection module for selecting a plurality of candidate universal data objects from the objects in the object graph;
a clustering module for clustering the candidate universal data objects to select a plurality of universal data objects; and
a merging module for merging the selected universal data objects to allow sharing of data between the set of source schemas.

18. The system of claim 17 wherein the schema processing calculates the degree of sharing score for each object by calculating the sum of:
a structural sharing score for the object;
a value relationship score for the object; and
a foreign key relationship score for the object.

19. A computer program product having a plurality of executable instruction codes embedded on a computer-readable medium, for automatically discovering a plurality of universal data objects, comprising:
a first set of instruction codes for generating an object graph from a set of source schemas, a plurality of similarities between objects in the set of source schemas, and a plurality of additional metadata describing the set of source schemas;
a second set of instruction codes for calculating a degree of sharing score for a plurality of objects in the object graph;
a third set of instruction codes for selecting a plurality of candidate universal data objects from the objects in the object graph;
a fourth set of instruction codes for clustering the candidate universal data objects to select a plurality of universal data objects; and
a fifth set of instruction codes for merging the selected universal data objects to allow sharing of data between the set of source schemas.

20. A method of providing a service for automatically discovering a plurality of universal data objects, comprising:
specifying a set of data sources for which universal data objects are identified;
specifying a set of control parameters and additional metadata;
invoking an automatic universal data object discovery utility, wherein the specified set of data sources, the specified control parameters, and the additional metadata are made available to the automatic universal data object discovery utility for consideration; and
receiving an object graph with identified universal data objects from the automatic universal data object discovery utility.
